(19) United States
(12) Patent Application Publication
(10) Pub. No.: US 2018/0203429 A1
(43) Pub. Date: Jul. 19, 2018

(54) CONTROLLER

(71) Applicant: FANUC Corporation, Yamanashi (JP)

(72) Inventors: Yoshifumi WAKE, Yamanashi (JP); Osamu HANAOKA, Yamanashi (JP); Souichirou IDE, Yamanashi (JP)

(21) Appl. No.: 15/867,879

(22) Filed: Jan. 11, 2018

(30) Foreign Application Priority Data
Jan. 18, 2017 (JP) 2017-006585

(51) Int. Cl. G05B 19/27; B23Q 17/22; G01B 5/008

(52) U.S. Cl. CPC G05B 19/27; B23Q 17/2233; G05B 2219/39483; G05B 2219/37077; G05B 2219/34212; G01B 5/008

(57) ABSTRACT

A controller includes a reference-sphere position obtaining unit that obtains coordinate values, on three linear axes, of a reference sphere placed on a table. The coordinate values are measured by controlling the three linear axes while a target rotation axis for which rotation axis center position is to be measured is positioned at three or more locations. The controller includes a rotation-axis commanded-angle obtaining unit that obtains commanded angles given to the target rotation axis during obtainment of a position of the reference sphere. The controller includes an approximate circle calculating unit that calculates an approximate circle passing near the coordinate values of the reference sphere on the three linear axes under a constraint of the commanded angles. The controller includes a rotation axis position storage unit that stores a center position of the approximate circle as coordinates of a center position of the target rotation axis.

### BACKGROUND OF THE INVENTION

### 1. Field of the Invention

The present invention relates to a controller, in particular to a controller capable of accurate measurement of the center position of a rotation axis.

### 2. Description of the Related Art

A known rotation axis position measurement method for determining the rotation center of a rotation axis for a 5-axis machine tool is to measure the center position of a reference sphere fixed on a table at multiple indexing angles of the rotation axis (Japanese Patent No. 3917114, for instance). Simple known methods include one that measures a reference sphere at two locations such as 0 degrees and 90 or 180 degrees and calculates the rotation center from the angle formed by the coordinate values at the two points, and one that computes the rotation center from the coordinate values of a reference sphere measured at three indexing positions. Another known method measures a reference sphere with indexing of the rotation axis at four or more locations, and determines the center of an approximate circle that minimizes errors using an evaluation function such as the least square method.

In the following, a method that measures a reference sphere at three indexing positions will be shown by way of example.

FIG. 7 illustrates a method of determining a rotation center for a machine tool having a rotation axis in a table. For a machine tool having a rotation axis in a table, a reference sphere placed on the table is indexed at three locations and the position of the reference sphere is measured with a sensor such as a touch probe attached to a spindle. In measuring the position of the reference sphere, the sensor is moved toward the reference sphere from multiple directions (three or four directions) to measure the coordinates of the reference sphere, and the multiple coordinates measured are averaged to determine the position (the center coordinates) of the reference sphere. Then, based on the positions of the reference sphere respectively indexed at the three locations, (X_{P1}, Y_{P1}, Z_{P1}), (X_{P2}, Y_{P2}, Z_{P2}), and (X_{P3}, Y_{P3}, X_{P3}), the center position of the table rotation axis, (X_{c}, Y_{c}, Z_{c}), is computed.

FIG. 8 illustrates a method of determining a rotation center for a machine tool having a rotation axis on the spindle side. For a machine tool having a rotation axis on the spindle side, the position of a reference sphere placed on the table is measured by positioning the spindle-side rotation axis carrying a sensor, such as a touch probe, at three angles, and driving the linear axes with the rotation axis fixed at those angles. In measuring the position of the reference sphere, the sensor is moved toward the reference sphere from multiple directions (three or four directions) to measure the coordinates of the reference sphere, and the multiple coordinates measured are averaged to determine the position (the center coordinates) of the reference sphere. Then, based on the respective positions, (X_{P1}, Y_{P1}, Z_{P1}), (X_{P2}, Y_{P2}, Z_{P2}), (X_{P3}, Y_{P3}, Z_{P3}), of the reference sphere measured with the spindle-side rotation axis positioned at the three angles, the center position of the spindle-side rotation axis, (X_{c}, Y_{c}, Z_{c}), is computed.

The center coordinates of the reference sphere corresponding to the individual indexing positions of the rotation axis are measured by moving a sensor, such as a touch probe, toward the reference sphere and obtaining the coordinates when the sensor has detected the reference sphere (that is, when the touch probe has touched the reference sphere and output a signal). However, there are delays associated with various factors (for example, delay in signal detection or delay in acquisition of coordinate values) from when the sensor detects the reference sphere to when the coordinate values are acquired. This introduces errors into the center coordinate values of the reference sphere on each indexing of the rotation axis as shown in FIGS. 9 and 10, which can leads to incorrect determination of the rotation center.

### SUMMARY OF THE INVENTION

An object of the present invention is therefore to provide a controller capable of accurate measurement of the center position of a rotation axis.

In measurement of the center position of a rotation axis, the present invention adds a constraint that a commanded angle for the rotation axis given from the controller to a machine tool during measurement of the reference sphere is employed as an azimuth from the rotation center, in addition to coordinate values in (X, Y, Z) directions of a reference sphere resulting from measurement with a sensor, and determines an approximate circle through evaluation with an evaluation function so as to reduce the effect of measurement errors, thereby solving the above issue.

A controller according to the present invention is for controlling a machine tool that moves a tool relatively to a workpiece placed on a table via axes including three linear axes and at least one rotation axis, the controller including: a reference-sphere position obtaining unit that obtains coordinate values, on the three linear axes, of a reference sphere placed on the table, the coordinate values being measured by controlling the three linear axes while a target rotation axis included in the at least one rotation axis is positioned at three or more locations; a rotation-axis commanded-angle obtaining unit that obtains commanded angles given to the target rotation axis at the respective locations at which the target rotation axis was positioned during the measurement; an approximate circle calculating unit that calculates an approximate circle passing near the coordinate values of the reference sphere on the three linear axes under a constraint of the commanded angles, based on the coordinate values of the reference sphere on the three linear axes obtained by the reference-sphere position obtaining unit and the commanded angles given to the target rotation axis obtained by the rotation-axis commanded-angle obtaining unit; and a rotation axis position storage unit that stores a center position of the approximate circle calculated by the approximate circle calculating unit as coordinates of a center position of the target rotation axis.

According to the present invention, the rotation center position of a rotation axis can be determined with increased accuracy so that improvement in machining accuracy is expected when the rotation axis is used.

### BRIEF DESCRIPTION OF THE DRAWINGS

The above and other objects and features of the present invention will become apparent from the following description of embodiments taken in conjunction with reference to the accompanying drawings, in which:

FIG. 1 illustrates difference in the way of determining a rotation center for a machine tool having a rotation axis in a table between a prior art technique and the present invention;

FIG. 2 illustrates difference in the way of determining a rotation center for a machine tool having a rotation axis on the spindle side between a prior art technique and the present invention;

FIG. 3 illustrates a method of determining a rotation center for a machine tool having a rotation axis in a table according to the present invention;

FIG. 4 illustrates a method of determining a rotation center for a machine tool having a rotation axis on the spindle side according to the present invention;

FIG. 5 is a schematic hardware configuration diagram of a controller according to an embodiment of the present invention;

FIG. 6 is a schematic functional block diagram of the controller according to an embodiment of the present invention;

FIG. 7 illustrates a method of determining a rotation center for a machine tool having a rotation axis in a table according to a prior art technique;

FIG. 8 illustrates a method of determining a rotation center for a machine tool having a rotation axis on the spindle side according to a prior art technique;

FIG. 9 illustrates a problem of the method of determining a rotation center for a machine tool having a rotation axis in a table according to a prior art technique; and

FIG. 10 illustrates a problem of the method of determining a rotation center for a machine tool having a rotation axis on the spindle side according to a prior art technique.

### DETAILED DESCRIPTION OF THE PREFERRED EMBODIMENTS

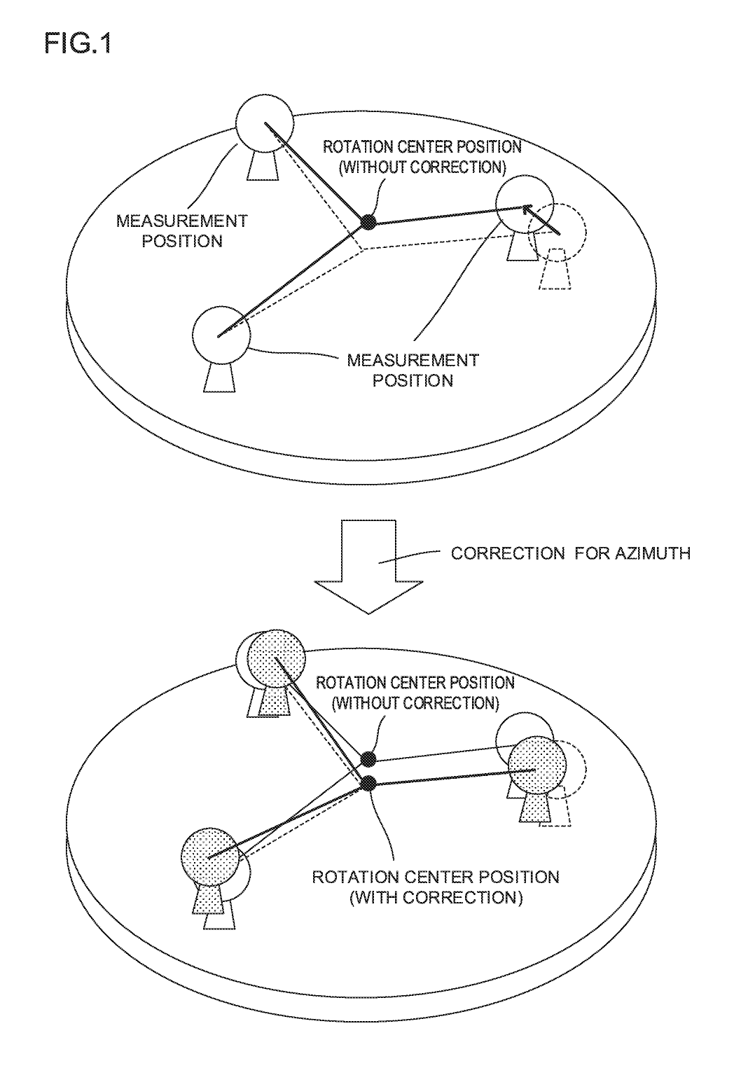

Embodiments of the present invention will be described below in connection with drawings. First, referring to FIGS. 1 to 4, a rotation axis center position measuring function implemented in a controller of the present invention is generally described.

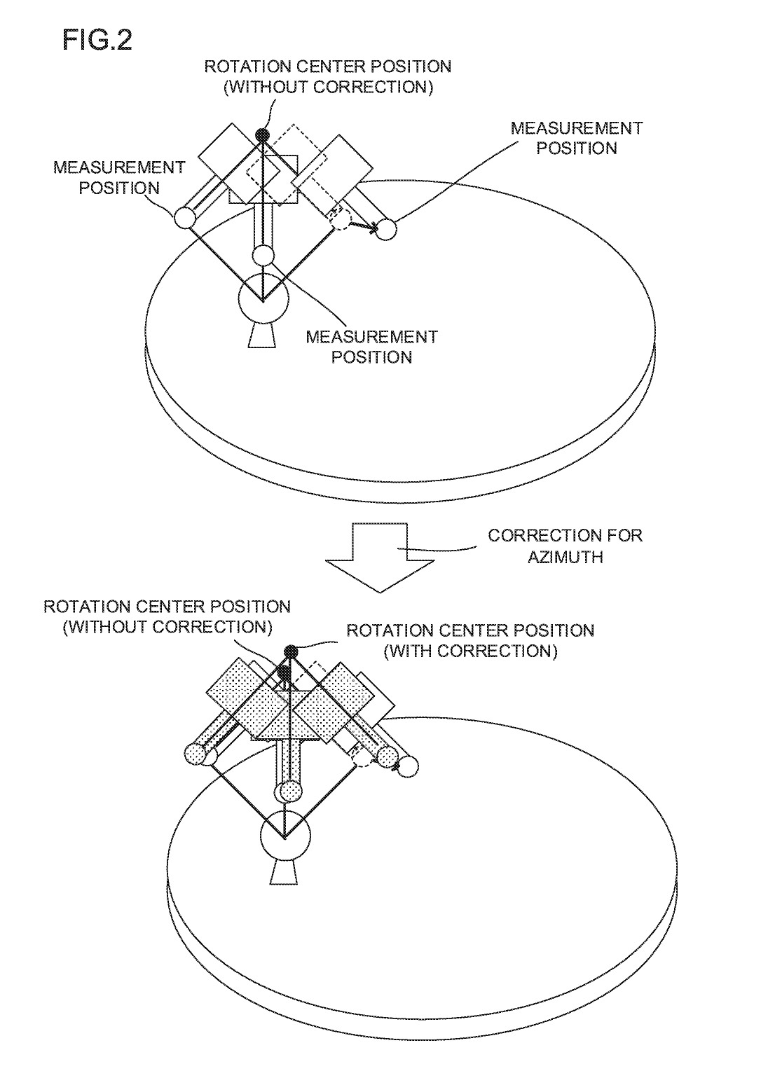

When computing a rotation axis center based on the coordinate values of a reference sphere in (X, Y, Z) directions resulting from measurement with a sensor, the controller of the present invention uses rotation-axis commanded angles in commands for indexing a reference sphere placed on a table at three locations in the case of a machine tool having a rotation axis in a table, or uses rotation-axis commanded angles in commands for positioning the spindle-side rotation axis carrying a sensor at three angles in the case of a machine tool having a rotation axis on the spindle side, to determine an approximate circle that has been corrected for azimuth under the constraint of the rotation-axis commanded angles as shown in FIGS. 1 and 2, thereby obtaining a solution closer to the true rotation center.

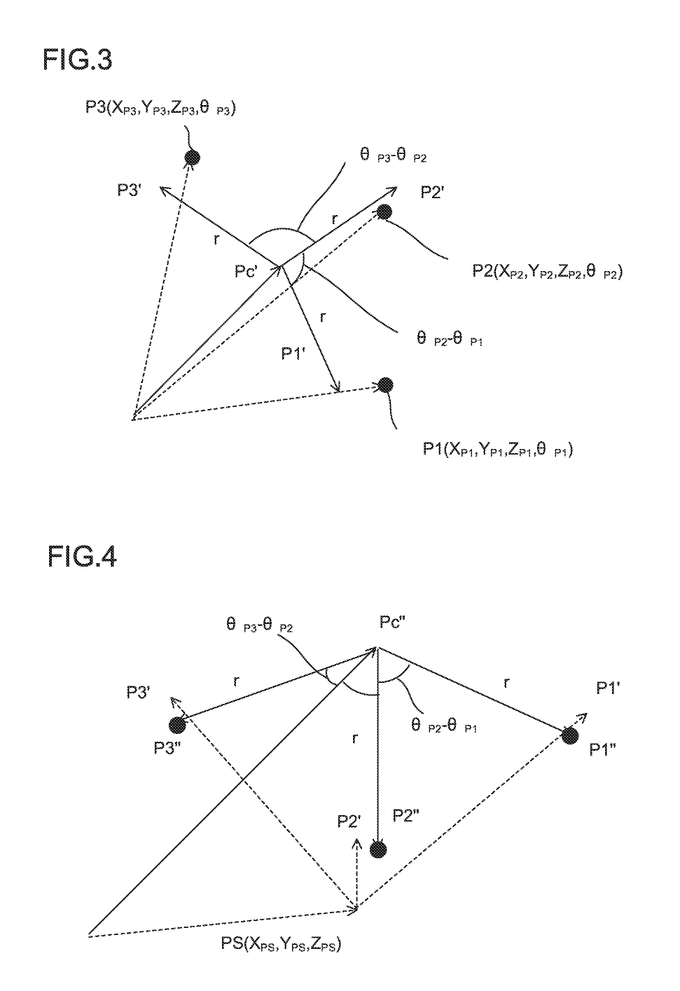

FIG. 3 illustrates a method of computing a rotation axis center for a machine tool having a rotation axis in the table. Assuming that the rotation axis center position of the table-side rotation axis of the machine tool (hereinafter referred to as “C-axis”) is to be measured and a reference sphere P is placed on the table at a predetermined position, the controller is manipulated by an operator (or automatically by a measurement program) to index the rotation axis of the table, C-axis, at certain angles, and the position of the reference sphere is measured at the individual indexing positions by a sensor attached to the spindle. For example, the C-axis is indexed at three locations (indexing angles, θ_{P1}, θ_{P2}, θ_{P3}) and the center coordinates of the reference sphere are measured at each of the indexing positions. By the operator repeating measurement on the reference sphere from multiple directions (three or four directions) at the different indexing angles of the C-axis, the controller obtains coordinate values (X_{P1}, Y_{P1}, Z_{P1}), (X_{P2}, Y_{P2}, Z_{P2}), (X_{P3}, Y_{P3}, Z_{P3}) corresponding to the reference sphere center P1, P2, and P3, and stores combinations of the coordinate values of the reference sphere center and the indexing angles, (X_{P1}, Y_{P1}, Z_{P1}, θ_{P1}), (X_{P2}, Y_{P2}, Z_{P2}, θ_{P2}), and (X_{P3}, Y_{P3}, Z_{P3}, θ_{P3}).

Based on the combinations of the coordinate values of the reference sphere center at the three points and the indexing angles, the controller of the present invention determines an approximate circle centered at Pc′ and passing through points P1′, P2′, and P3′ near P1, P2, and P3. The controller of the present invention determines an approximate circle for which the angle formed by straight line Pc′P1′ and straight line Pc′P2′ is θ_{P2}-θ_{P1} and the angle formed by straight line Pc′P2′ and straight line Pc′P3′ is θ_{P2}-θ_{P1} and also an evaluation function (for example, the root mean square, |P1P1′|²+|P2P2′|²+|P3P3′|²) is minimized, as shown in FIG. 3. The center of this approximate circle, Pc′, can then be considered as the center position of the rotation axis to be determined.

FIG. 4 illustrates a method of computing a rotation axis center for a machine tool having a rotation axis on the spindle side. Assuming that the rotation axis center position of a rotation axis which is centered about a direction substantially vertical to the spindle-side table of the machine tool (hereinafter referred to as “B-axis”) is to be measured and a reference sphere P is placed on the table at a predetermined position, the controller is manipulated by an operator (or automatically by a measurement program) to index the spindle-side rotation axis, B-axis, at certain angles, and the position of the reference sphere is measured at the individual indexing angles by a sensor attached to the spindle. For example, the B-axis is indexed at three locations (indexing angles, θ_{P1}, θ_{P2}, θ_{P3}) and the center coordinates of the reference sphere are measured at each of the indexing positions. By the operator repeating measurement on the reference sphere from multiple directions (three or four directions) at the different indexing angles of the B-axis, the controller obtains coordinate values (X_{P1}, Y_{P1}, Z_{P1}), (X_{P2}, Y_{P2}, Z_{P2}), and (X_{P3}, Y_{P3}, Z_{P3}) corresponding to the reference sphere center P1, P2, and P3, and stores combinations of the coordinate values of the reference sphere center and the indexing angles, (X_{P1}, Y_{P1}, Z_{P1}, θ_{P1}), (X_{P2}, Y_{P2}, Z_{P2}, θ_{P2}), and (X_{P3}, Y_{P3}, Z_{P3}, θ_{P3}).

When the coordinates of the position PS of the reference sphere in a machine coordinate system are defined as (X_{PS}, Y_{PS}, Z_{PS}), point P1′ is defined as PS−P1, point P2′ is defined as PS−P2, and point P3′ is defined as PS−P3, the controller of the present invention determines an approximate circle centered at Pc″ and passing through points P1″, P2″, and P3″ near Pr, P2′, and P3′, based on the combinations of the coordinate values of the three points (P1′, P2′, P3′) and the indexing angles. The controller of the present invention determines an approximate circle for which the angle formed by straight line Pc″P1″ and straight line Pc“P2” is θ_{P2}−θ_{P1} and the angle formed by straight line Pc″P2″ and straight line Pc″P3″ is θ_{P3}−θ_{P2} and also an evaluation function (for example, the root mean square, |P1′P1″|²+|P2P2″|²+|P3′P3″|²) is minimized, as shown in FIG. 4. The center of this approximate circle, Pc″, can then be considered as the center position of the rotation axis to be determined.

Hereinbelow, the configuration of the controller implemented as a numerical controller according to an embodiment of the present invention will be described.

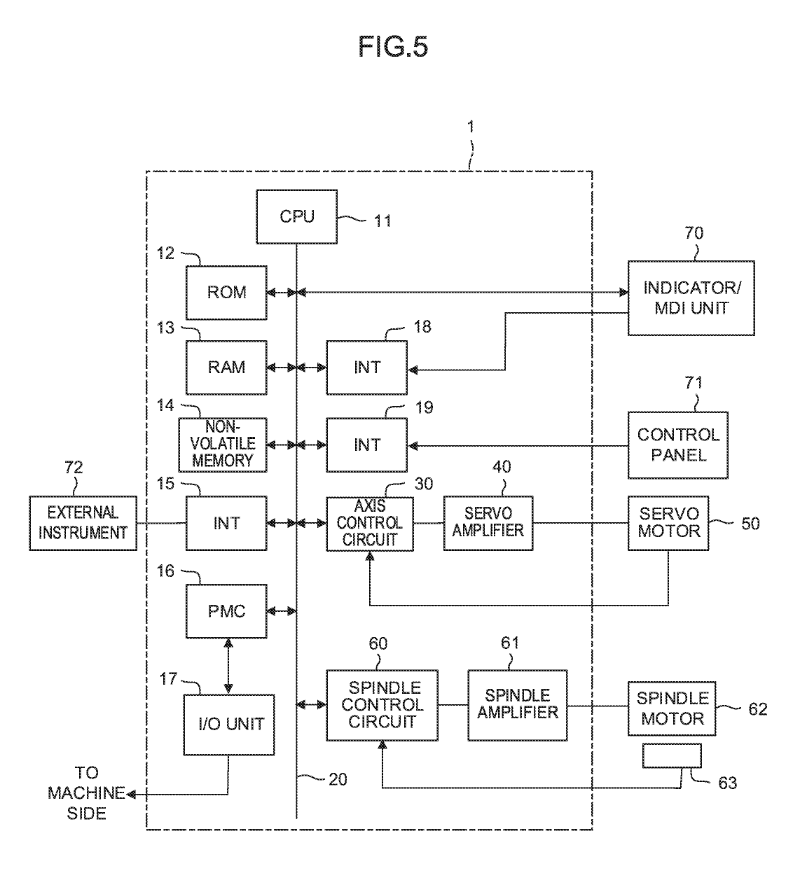

FIG. 5 is a hardware configuration diagram showing primary components of the numerical controller according to an embodiment of the present invention and a machine tool driven and controlled by the numerical controller. A CPU 11 of a numerical controller 1 is a processor that controls the entire numerical controller 1. The CPU 11 reads a system program stored in a. ROM 12 via a bus 20 and controls the entire numerical controller 1 in accordance with the system program. A RAM 13 stores temporary calculation data or display data and various kinds of data entered by the operator via an indicator/Mal unit 70 described below.

A non-volatile memory 14 is implemented as a memory that retains its storage state even when the numerical controller 1 is powered off such as by being backed up by a battery not shown, for example. The non-volatile memory 14 has stored therein a machining program loaded via an interface 15 and/or a machining program input via the indicator/MDI unit 70 described below. The non-volatile memory 14 also stores a machining program operation program used for operating the machining program and other programs, and such programs are loaded to the RAM 13 at the time of execution. The ROM 12 prestores various system programs (including a system program for measuring a rotation axis center position) for performing, for example, editing mode processing necessary for creation and edition of machining programs.

The interface 15 is an interface connecting between the numerical controller 1 and an external instrument 72, such as an adapter. From the external instrument 72, machining programs, various parameters, and the like are loaded. A machining program edited in the numerical controller 1 may be stored in an external storage means via the external instrument 72. A programmable machine controller (PMC) 16 outputs signals to and controls peripherals for the machine tool (for example, an actuator such as a robot hand for tool replacement) via an I/O unit 17 in accordance with a sequence program contained in the numerical controller 1. The PMC 16 also receives signals from various switches and the like on a control panel provided at the main unit of the machine tool and performs necessary signal processing on the signals before passing them to the CPU 11.

The indicator/MDI unit 70 is a manual data input device having, for example, a display and/or a keyboard, and the interface 18 receives commands and data from the keyboard of the indicator/MDI unit 70 and passes them to the CPU 11. An interface 19 is connected with a control panel 71, which includes a manual pulse generator for use in manual driving of axes, for example.

An axis control circuit 30 for controlling the axes of the machine tool outputs an axis command to a servo amplifier 40 in response to a command on the amount of axis movement from the CPU 11. In response to the command, the servo amplifier 40 drives a servo motor 50 which moves the axes of the machine tool. The servo motor 50 for axes includes a position/speed detector, and a position/speed feedback signal from the position/speed detector is sent back to the axis control circuit 30 for feedback control of the position and/or the speed. Although one axis control circuit 30, one servo amplifier 40, and one servo motor 50 are shown in the hardware configuration diagram of FIG. 5, they are actually prepared as many as the number of axes the machine tool is equipped with. For example, for the numerical controller controlling the machine tool according to the present embodiment, axis control circuits 30, servo amplifiers 40, and servo motors 50 will be each prepared as many as the three linear axes plus at least one rotation axis.

A spindle control circuit 60 outputs a spindle speed signal to a spindle amplifier 61 in response to a spindle rotate command to the machine tool. In response to the spindle speed signal, the spindle amplifier 61 rotates a spindle motor 62 of the machine tool at a rotation speed indicated by the command so as to drive a tool.

The spindle motor 62 is coupled with a position coder 63, which outputs a feedback pulse in synchronization with the rotation of the spindle, and the feedback pulse is then read by the CPU 11.

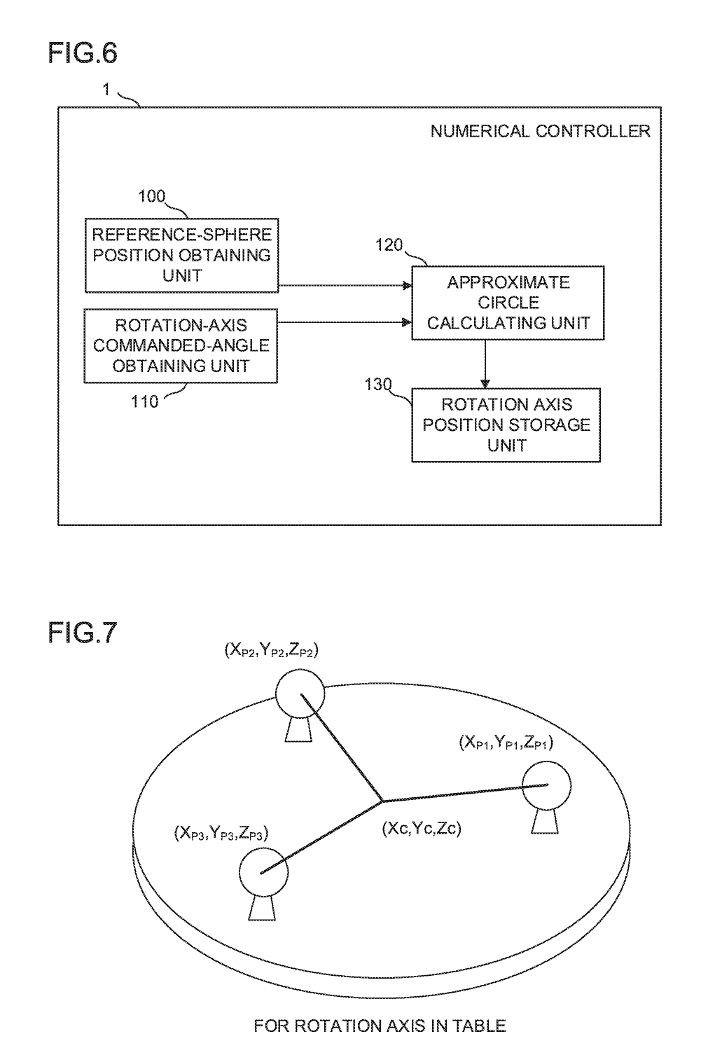

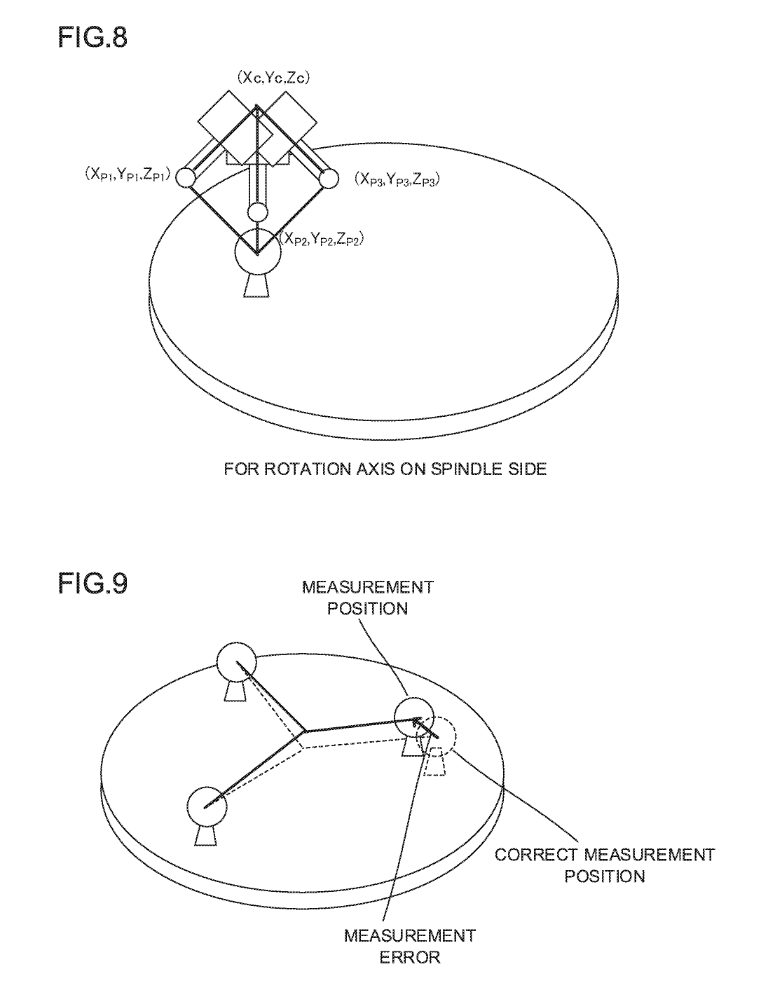

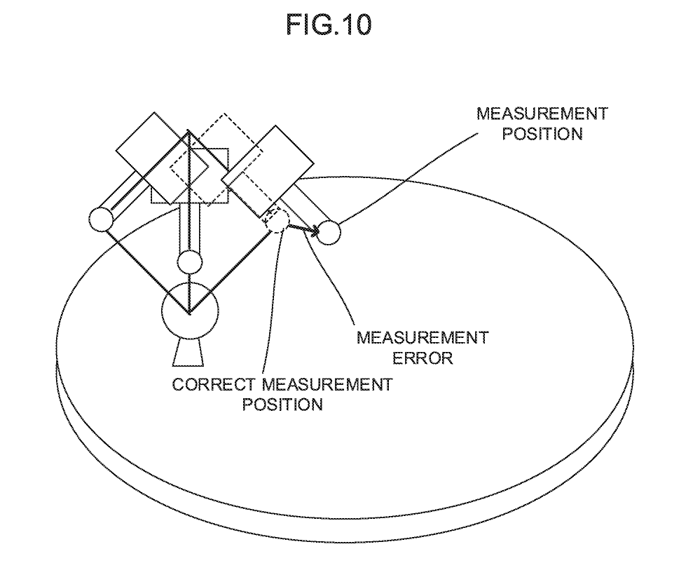

FIG. 6 is a schematic functional block diagram of a numerical controller according to an embodiment of the present invention, illustrating a case where a system program for performing the rotation axis center position measuring function described above is implemented in the numerical controller 1 shown in FIG. 5. The functional blocks shown in FIG. 6 are implemented by the CPU 11 of the numerical controller 1 shown in FIG. 5 executing a system program for searching for a machining program and controlling the operation of various portions of the numerical controller 1. The numerical controller 1 of the present embodiment includes a reference-sphere position obtaining unit 100, a rotation-axis commanded-angle obtaining unit 110, an approximate circle calculating unit 120, and a rotation axis position storage unit 130.

The reference-sphere position obtaining unit 100 is a functional means that obtains the coordinate position of a reference sphere placed on a table, measured either through manual operation by an operator or automated control by a measurement program. The reference-sphere position obtaining unit 100 may be configured as an interface for entering the coordinate position of the reference sphere measured through manual operation by the operator via the indicator/MDI unit or may be configured to automatically obtain the coordinate position of the reference sphere measured through automated control by a measurement program such as via signals, for example. The reference-sphere position obtaining unit 100 may obtain the position coordinates of the reference sphere indexed at three locations when controlling a machine tool having a rotation axis in the table, or obtain the position coordinates of the reference sphere measured by indexing the rotation axis of the spindle at three angles when controlling a machine tool having a rotation axis on the spindle side, for example. The reference-sphere position obtaining unit 100 outputs the obtained position coordinates of the reference sphere to the approximate circle calculating unit 120.

The rotation-axis commanded-angle obtaining unit 110 is a functional means that obtains commanded angles that are being commanded to the rotation axis when the reference sphere position is obtained by the reference-sphere position obtaining unit 100. For example, in controlling a machine tool having a rotation axis in the table, the rotation-axis commanded-angle obtaining unit 110 may obtain commanded angles for the C-axis respectively corresponding to three locations at which the C-axis is indexed when obtaining the position coordinates of the reference sphere. In controlling a machine tool having a rotation axis on the spindle side, the rotation-axis commanded-angle obtaining unit 110 may obtain the commanded angles for the B-axis respectively corresponding to three angles at which the rotation axis of the spindle is indexed when obtaining the position coordinates of the reference sphere. The rotation-axis commanded-angle obtaining unit 110 outputs the obtained commanded angles of when the position coordinates of the reference sphere were obtained to the approximate circle calculating unit 120.

The approximate circle calculating unit 120 is a functional means that performs the approximate circle computation process described with FIGS. 3 and 4 to determine an approximate circle based on the coordinate position of the reference sphere received from the reference-sphere position obtaining unit 100 and the commanded angles of the rotation axis during obtainment of the reference sphere coordinate position received from the rotation-axis commanded-angle obtaining unit 110.

The rotation axis position storage unit 130 then stores the center position of the approximate circle determined by the approximate circle calculating unit 120 as the center position of the rotation axis in a storage area prepared such as in the RAM 13 or the non-volatile memory 14 of the numerical controller 1.

While the embodiments of the present invention have been described above, the present invention is not limited to those embodiments and may be practiced in various manners with appropriate modifications.

For example, the above embodiments described a case of measuring a reference sphere with indexing at three locations (a case of measuring the rotation axis of the spindle as indexed at three angles) as an example. However, the rotation axis center measurement method of the present invention is applicable to any determination of the rotation center of a rotation axis with indexing of a reference sphere at three or more locations (a case of measuring the rotation axis of the spindle with indexing at three or more angles). For instance, for measurement of the rotation axis center of a table by indexing a reference sphere at four or more locations, the center of an arc and a radius that minimize an evaluation function (for example, the root mean square of a measurement point and a corrected distance) may be similarly calculated under the constraint of commanded angles for indexing, thus determining the rotation axis center position with smaller effect of measurement errors and closer to the actual machine.

Although the above described examples measure the center position of the rotation axis of the B- or C-axis, the rotation axis center measurement method of the present invention may also be employed to determine the rotation center of a rotation axis which is centered about a direction substantially horizontal to the spindle-side table of the machine tool (hereinafter referred to as “A-axis”). A machine tool having rotation axes can also have the A-axis on either the table side or the spindle side depending on implementation; in either case, the rotation axis center position of the A-axis can be measured by the foregoing method similarly to B- and C-axes.

While the embodiments of the present invention have been described above, the present invention is not limited to those embodiments and may be practiced in other manners with appropriate modifications.

1. A controller for controlling a machine tool that moves a tool relatively to a workpiece placed on a table via axes including three linear axes and at least one rotation axis, the controller comprising:
a reference-sphere position obtaining unit that obtains coordinate values, on the three linear axes, of a reference sphere placed on the table, the coordinate values being measured by controlling the three linear axes while a target rotation axis included in the at least one rotation axis is positioned at three or more locations;
a rotation-axis commanded-angle obtaining unit that obtains commanded angles given to the target rotation axis at the respective locations at which the target rotation axis was positioned during the measurement;
an approximate circle calculating unit that calculates an approximate circle passing near the coordinate values of the reference sphere on the three linear axes under a constraint of the commanded angles, based on the coordinate values of the reference sphere on the three linear axes obtained by the reference-sphere position obtaining unit and the commanded angles given to the target rotation axis obtained by the rotation-axis commanded-angle obtaining unit; and
a rotation axis position storage unit that stores a center position of the approximate circle calculated by the approximate circle calculating unit as coordinates of a center position of the target rotation axis.
